(19) United States
(12) Patent Application Publication
(10) Pub. No.: US 2007/0175678 A1
(43) Pub. Date: Aug. 2, 2007

(54) Multifunctional electric-powered infant car with cradle function

(76) Inventor: Myung-Soon Bae, Gumi (KR)

Correspondence Address: IPLA P.A., 3580 WILSHIRE BLVD., 17TH FLOOR, LOS ANGELES, CA, 90010, US

(21) Appl. No.: 10/597,743

(22) PCT Filed: Feb. 7, 2005
(86) PCT No.: PCT/KR05/00366

§ 371 Date: Aug. 4, 2006

(30) Foreign Application Priority Data
Feb. 11, 2004 (KR) 10-2004-0008907

(51) Int. Cl. B60K 1/00

(52) U.S. Cl. 180/65.1

(57) ABSTRACT

A multifunctional electric-powered infant car with cradle function comprises a car body (1) and a cradle unit (2). The cradle unit (2) is mounted on the car body (1) such that the cradle unit (2) can be moved back and forth. The cradle unit (2) has a supporting frame (21) vertically mounted to the car body (1) and an inclination-adjustable back part (23) for allowing an infant to be laid on the cradle unit (2). The carbody (1) comprises driving unit (13) mounted to the (11) a one-way rotating force generated from a driving motor (131) to driving wheels (133) via a driving force transmitting part (132), and a cradle driving unit (14) to receive the driving force generated from the driving motor (131) of the car body driving unit (13) for moving the cradle unit (2) back and forth.

### TECHNICAL FIELD

The present invention relates to a multifunctional electric-powered infant car with cradle function, and, more particularly, to a multifunctional electric-powered infant car with cradle function that can be simultaneously used not only as a cradle but also as an electric-powered infant car and that can also be selectively used in a manual or automatic fashion.

### BACKGROUND ART

Cradles, which are generally used not only as playing devices but also as auxiliary sleeping devices, are classified into hand-operated cradles, which are manually swung by human force, and electric-powered cradles, which are automatically swung by driving force generating units, such as motors. Such hand-operated cradles and electric-powered cradles have been developed in large numbers and placed on the market.

Infant cars, on which infants ride to have merry times as playing devices, are classified into hand-operated infant cars, which require infants to directly manipulate pedals of the hand-operated infant cars such that the hand-operated infant cars are moved, and electric-powered infant cars, which are automatically moved by additional driving units, including motors, for transmitting a driving force to driving wheels. Such hand-operated infant cars and electric-powered infant cars have also been developed in large numbers and placed on the market.

The above-mentioned cradles are usually used when babies are fed or sleep while the above-mentioned infant cars are usually used as playing devices for toddlers, who are relatively older than the babies. For this reason, the cradles and the infant cars must be individually purchased as infants grow up, which increases financial burdens of the parents of the infants. Also, periods of time within which the cradles and the infant cars are used are relatively short, and therefore, the cradles and the infant cars are discarded after they are used for predetermined periods of time, which deepens waste of resources and contaminates the environment.

Furthermore, the cradles and the infant cars have relatively large sizes, respectively, and therefore, it is very difficult to store or handle the cradles and the infant cars. Also, it is necessary to increase the sizes of the places where the cradles and the infant cars are stored. In the case of electric-powered infant cars, it is necessary that parents of the infants riding on the electric-powered infant cars pay attention to their infants' behavior to protect their infants against danger. Most of the electric-powered infant cars on the market today use built-in batteries as their power sources. However, the built-in batteries, which are charged using adapters, have problems in that charging time is too long and it is difficult to manage the batteries. As a result, the service lives of the batteries are shortened, and therefore, the service lives of the electric-powered infant cars are shortened.

### DISCLOSURE OF INVENTION

Therefore, the present invention has been made in view of the above problems, and it is an object of the present invention to provide a multifunctional electric-powered infant car with cradle function that can be simultaneously used not only as a cradle but also as an electric-powered infant car and that can also be selectively used in a manual or automatic fashion.

It is another object of the present invention to provide a multifunctional electric-powered infant car with cradle function that is capable of providing their parents' voices and music, that can be remote-controlled for their parents to easily and conveniently control the operations of the multifunctional electric-powered infant car with cradle function, that has a simple and durable structure, and that can be manufactured with reduced manufacturing costs.

In accordance with the present invention, the above and other objects can be accomplished by the provision of a multifunctional electric-powered infant car with cradle function comprising: a car body having a plurality of rolling wheels attached thereto, the car body being configured such that the car body can be moved by driving wheels operated in an electric-powered fashion; and a cradle unit mounted on the car body such that the cradle unit can be moved back and forth, the cradle unit having a supporting frame vertically mounted to the car body and an inclination-adjuatable back part for allowing an infant to be laid on the cradle unit, wherein the car body comprises: a car body driving unit mounted to the bottom part of the car body base for transmitting a one-way rotating force generated from a driving motor to the driving wheels via a driving force transmitting part; and a cradle driving unit configured to receive the driving force generated from the driving motor of the car body driving unit for moving the cradle unit back and forth.

Preferably, the driving force transmitting part comprises: a first one-way bearing fitted on a shaft of the driving motor; a driving gear disposed on the outer circumferential surface of the first one-way bearing; a driving force transmitting gear engaged with the driving gear for transmitting a driving force; a driven gear configured to be rotated while being engaged with the driving force transmitting gear; a wheel driving shaft fitted in a center hole of the driven gear such that the wheel driving shaft is rotatably supported by a plurality of bearings; a horizontal bevel gear attached to the lower end of the wheel driving shaft; a vertical bevel gear engaged with the horizontal bevel gear; a wheel shaft horizontally inserted in an inner hole defined in the vertical bevel gear such that the driving wheels are attached to both ends of the wheel shaft, respectively; and a driving wheel case rotatably fitted on the wheel driving shaft such that the driving wheels are surrounded by the driving wheel case, the driving wheel case being configured such that both ends of the wheel shaft are rotatably attached to the inner lower part of the driving wheel case.

Preferably, the multifunctional electric-powered infant car with cradle function further comprises: a torque spring for independently rotating the driving wheels when load is applied to the driving wheels, the torque spring having one end securely connected to the vertical bevel gear and the other end securely connected to one of the driving wheels, which is rotatably attached to the wheel shaft.

Preferably, the multifunctional electric-powered infant car with cradle function further comprises: a steering wheel unit detachably attached to the car body in front of the cradle unit; and a steering unit for controlling the direction in which the driving wheels roll through the manipulation of the steering wheel unit.

Preferably, the steering unit comprises: a steering gear disposed at the upper position of the outer circumferential surface of the driving wheel case; a steering force transmitting gear engaged with the steering gear; and a lower steering shaft attached to the car body such that the lower steering shaft can be rotated through a bearing, the lower steering shaft having the lower end fixedly inserted in the steering force transmitting gear, an upper steering shaft being detachably attached to the lower steering shaft.

Preferably, the driving force transmitting part comprises: a first one-way bearing fitted on a shaft of the driving motor; a driving gear disposed on the outer circumferential surface of the first one-way bearing; a driving force transmitting gear engaged with the driving gear for transmitting a driving force; a driven gear configured to be rotated while being engaged with the driving force transmitting gear; a wheel driving shaft fitted in a center hole of the driven gear such that the wheel driving shaft is rotatably supported by a plurality of bearings; a horizontal bevel gear attached to the lower end of the wheel driving shaft; a vertical bevel gear part attached to one of the driving wheels, which is engaged with the horizontal bevel gear; and a driving wheel case rotatably fitted on the wheel driving shaft such that the driving wheels are surrounded by the driving wheel case, the driving wheel case being configured such that both ends of the wheel shaft are rotatably attached to the inner lower part of the driving wheel case.

Preferably, the cradle driving unit comprises: a second one-way bearing fitted on the shaft of the driving motor; a driving pulley fitted on the outer circumferential surface of the second one-way bearing; a driving belt having one side connected to the driving pulley for transmitting a driving force; a driving force transmitting pulley connected to the other side of the driving belt; a swing shaft rotatably attached to the car body such that the swing shaft can be rotated by the driving force transmitting pulley; and a swing force transmitting member for moving the cradle unit back and forth by means of the driving force transmitted to the swing shaft.

Preferably, the swing force transmitting member comprises: a rotary plate attached to the upper end of the swing shaft; swing levers vertically disposed in front of and at the rear of the supporting frame of the cradle unit, respectively; a rubber belt connected between the swing levers; and a connection piece for securely connecting the approximate middle part of the rubber belt and one side of the rotary plate.

Preferably, the electric-powered infant car with cradle function further comprises: a driving input unit having selection switches for selecting the operation of the cradle unit and the operation of the car body, respectively, and selection switches for selecting the manual operation and the remote control operation, respectively; a control unit for controlling the respective components, including the driving motor, based on the selection through the driving input unit; a remote controller receiving unit for receiving control signals transmitted from a transmitting part of a remote controller having a plurality of input buttons and transmitting the control signals to the control unit; a power supply unit for supplying electric current to the respective components under the control of the control unit; a motor driving unit for driving the driving motor in the forward or reverse direction based on the control signals of the control unit; an overload detection unit for detecting overload of the driving motor and transmitting the detected overload to the control unit; and a sound controller for controlling sound of a sound device, including a speaker, under the control of the control unit.

Preferably, the multifunctional electric-powered infant car with cradle function further comprises: a steering sub motor having a shaft, on which a sub motor gear is fitted such that the driving wheels are operated; a steering wheel position detecting part mounted adjacent to the sub motor gear for detecting the position of a steering wheel; and a steering sub motor driving part configured to receive the detected signal from the steering wheel position detecting part for driving the steering sub motor under the control of the control unit.

Preferably, the multifunctional electric-powered infant car with cradle function further comprises: a plurality of ultrasonic sensor parts disposed at the front and rear ends of the car body for detecting obstructions such that the operation of the steering sub motor is controlled by the control unit based on signals detected by the ultrasonic sensor parts.

The multifunctional electric-powered infant car with cradle function according to the present invention can be used not only as a cradle but also as an electric-powered infant car. Consequently, the present invention has the effect of reducing burdens of consumers. Also, the present invention has the effect of not requiring large spaces for storing the multifunctional electric-powered infant car with cradle function according to the present invention, reducing waste of resources, and preventing contamination of the environment.

According to the multifunctional electric-powered infant car with cradle function according to the present invention, parents' voices and music can be provided to their infants. Consequently, the present invention has the effect of helping develop the infants' emotion. Also, the multifunctional electric-powered infant car with cradle function according to the present invention can be remote-controlled for their parents to easily and conveniently control the operations of the multifunctional electric-powered infant car with cradle function. In addition, the multifunctional electric-powered infant car with cradle function according to the present invention is operated by a single driving motor while performing various different functions. Consequently, the present invention has the effect of simplifying the structure of the multifunctional electric-powered infant car with cradle function, improving the durability of the multifunctional electric-powered infant car with cradle function, and manufacturing the multifunctional electric-powered infant car with cradle function with reduced manufacturing costs.

According to the multifunctional electric-powered infant car with cradle function according to the present invention, the driving input unit and the power supply unit are protected by the protection cover. Consequently, the present invention has the effect of preventing the infant from incorrectly manipulating switches of the driving input unit or disassembling the storage battery of the power supply unit, and therefore, preventing the multifunctional electric-powered infant car with cradle function from being damaged or preventing the infant from being injured.

### BRIEF DESCRIPTION OF DRAWINGS

The above and other objects, features and other advantages of the present invention will be more clearly understood from the following detailed description taken in conjunction with the accompanying drawings, in which:

FIG. 1 is a side view schematically illustrating the overall structure of a multifunctional electric-powered infant car with cradle function according to a first preferred embodiment of the present invention;

FIG. 2 is a side view, in section, schematically illustrating the overall structure of the multifunctional electric-powered infant car with cradle function according to the first preferred embodiment of the present invention;

FIG. 3A is a plan view of the multifunctional electric-powered infant car with cradle function according to the first preferred embodiment of the present invention;

FIG. 3B is a bottom view of the multifunctional electric-powered infant car with cradle function according to the first preferred embodiment of the present invention;

FIGS. 4A to 4C are enlarged views respectively illustrating the “A” part of FIG. 2;

FIG. 5A is an exploded perspective view, in large scale, illustrating the “C” part of FIG. 4A;

FIG. 5B is an exploded perspective view, in large scale, illustrating the “D” part of FIG. 4C;

FIG. 6 is a view schematically illustrating swinging operations of a cradle unit of the multifunctional electric-powered infant car with cradle function according to the first preferred embodiment of the present invention shown in FIG. 1;

FIG. 7 is an enlarged view, in section, illustrating the “B” part of FIG. 2;

FIG. 8 is a block diagram illustrating the construction of the multifunctional electric-powered infant car with cradle function according to the first preferred embodiment of the present invention;

FIG. 9A is a block diagram illustrating the construction of a multifunctional electric-powered infant car with cradle function according to a second preferred embodiment of the present invention;

FIG. 9B is a sectional view, in part, schematically illustrating the structure of the multifunctional electric-powered infant car with cradle function according to the second preferred embodiment of the present invention;

FIG. 10A is a block diagram illustrating the construction of a multifunctional electric-powered infant car with cradle function according to a third preferred embodiment of the present invention; and

FIG. 10B is a plan view of the electric-powered infant car with cradle function according to the third preferred embodiment of the present invention illustrating ultrasonic sensor parts mounted to a car body of the multifunctional electric-powered infant car with cradle function.

### MODES FOR CARRYING OUT THE INVENTION

Now, preferred embodiments of the present invention will be described in detail with reference to the accompanying drawings.

First, a first preferred embodiment of the present invention will be described in detail.

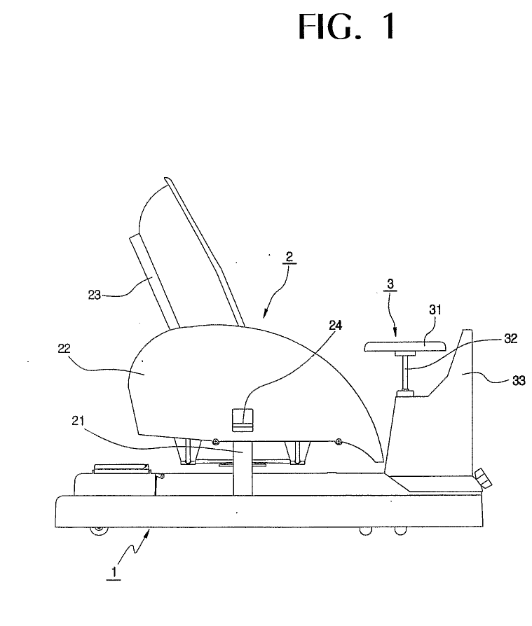

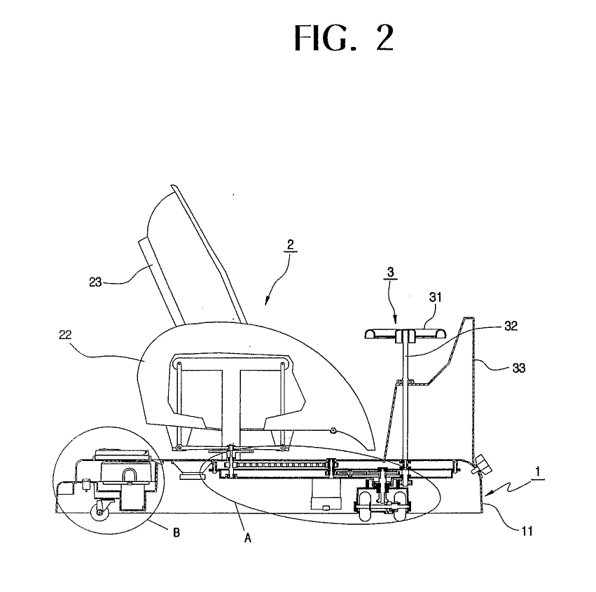

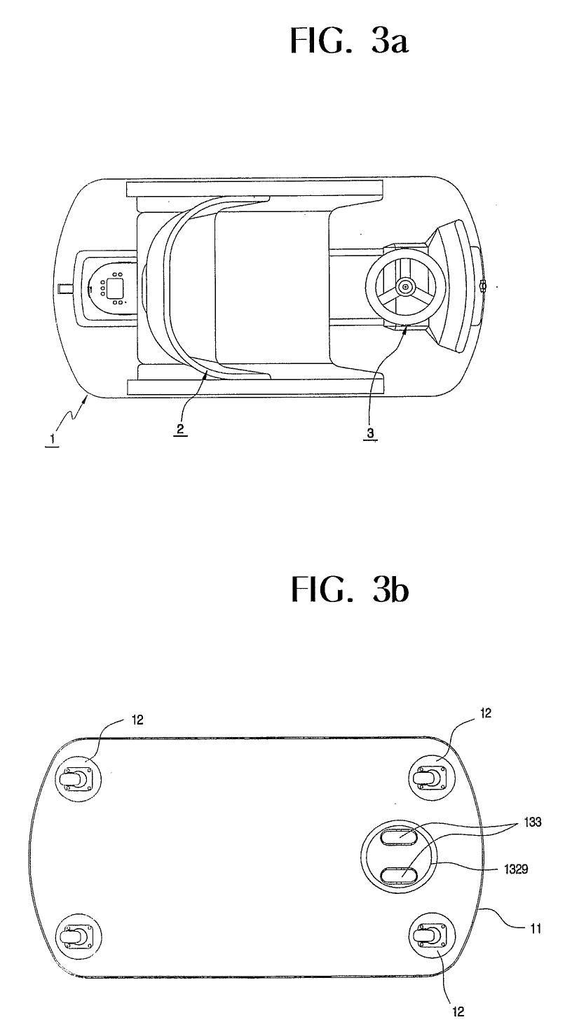

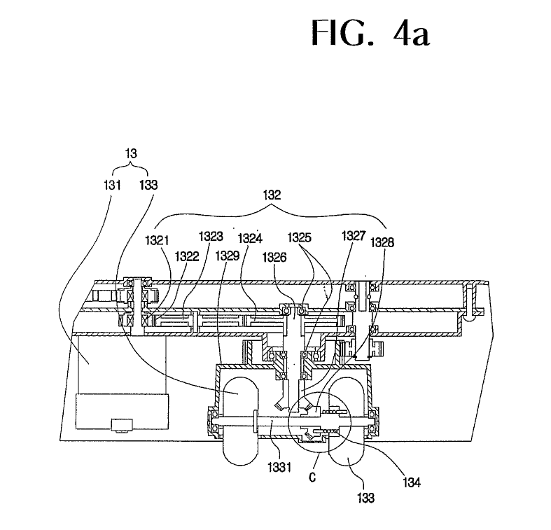

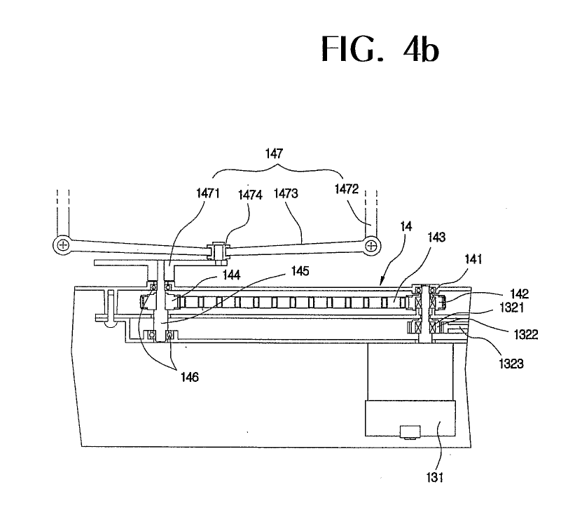

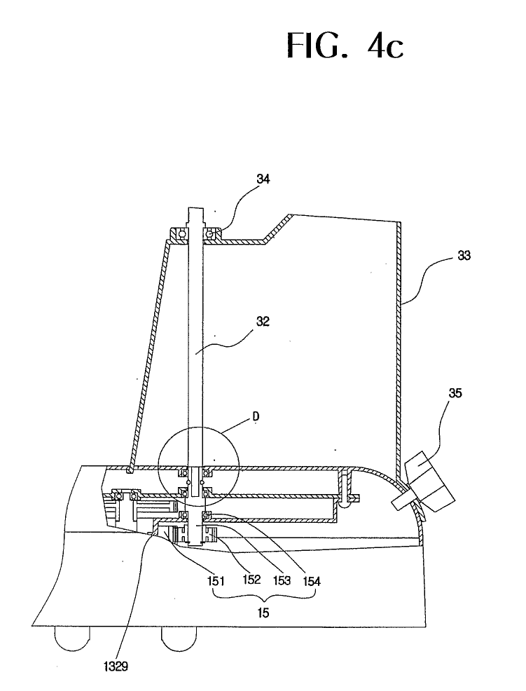

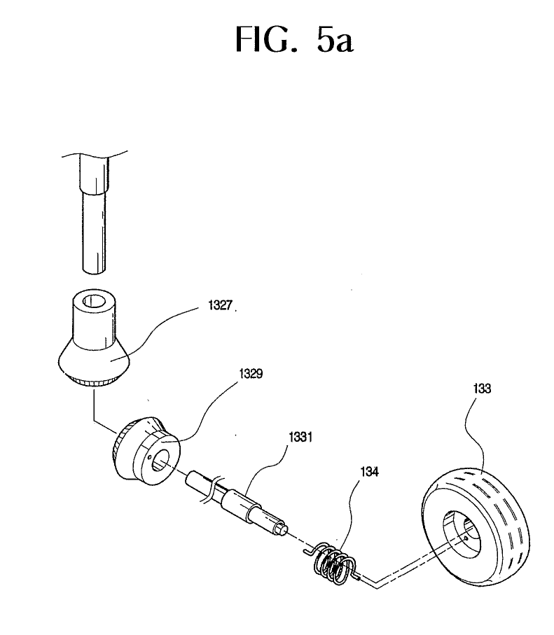

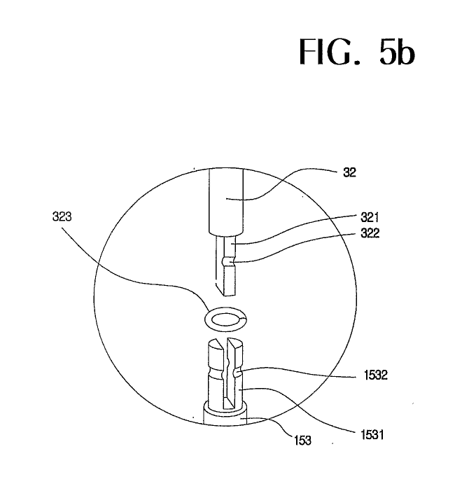

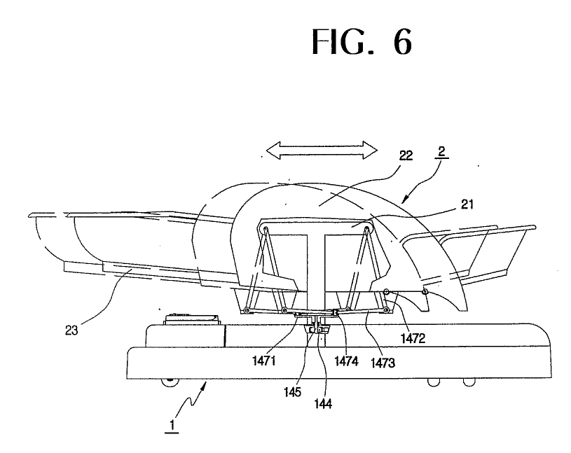

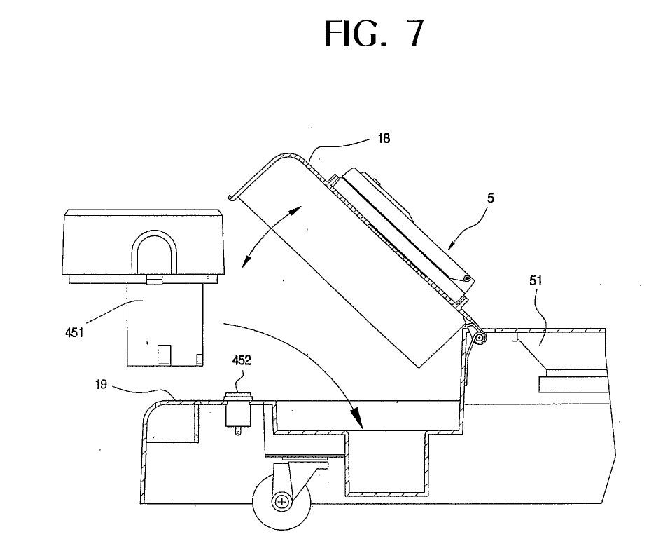

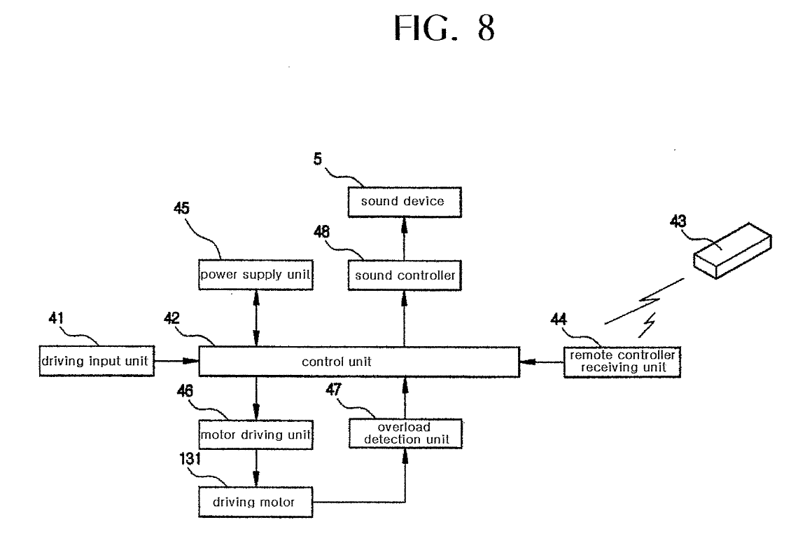

FIG. 1 is a side view schematically illustrating the overall structure of a multifunctional electric-powered infant car with cradle function according to a first preferred embodiment of the present invention, FIG. 2 is a side view, in section, schematically illustrating the overall structure of the multifunctional electric-powered infant car with cradle function according to the first preferred embodiment of the present invention, FIG. 3A is a plan view of the multifunctional electric-powered infant car with cradle function according to the first preferred embodiment of the present invention, FIG. 3B is a bottom view of the multifunctional electric-powered infant car with cradle function according to the first preferred embodiment of the present invention, FIGS. 4A to 4C are enlarged views respectively illustrating the “A” part of FIG. 2, FIG. 5A is an exploded perspective view, in large scale, illustrating the “C” part of FIG. 4A, FIG. 5B is an exploded perspective view, in large scale, illustrating the “D” part of FIG. 4C, FIG. 6 is a view schematically illustrating swinging operations of a cradle unit of the multifunctional electric-powered infant car with cradle function according to the first preferred embodiment of the present invention shown in FIG. 1, FIG. 7 is an enlarged view, in section, illustrating the “B” part of FIG. 2, and FIG. 8 is a block diagram illustrating the construction of the multifunctional electric-powered infant car with cradle function according to the first preferred embodiment of the present invention.

As shown in FIG. 1, the multifunctional electric-powered infant car with cradle function comprises: a car body 1 movable on a floor; a cradle unit 2 mounted on the car body 1 such that the cradle unit 2 can be moved back and forth, the cradle unit 2 being provided with an inclination-adjustable back part 23; and a steering wheel unit 3 mounted on the car body 1 in front of the cradle unit 2.

As shown in FIGS. 2, 3A and 3B, the car body 1 comprises: a car body base 11 formed approximately in the shape of an oval; a plurality of rolling wheel mounted on the outer bottom surface of the car body base 11; a car body driving unit 13 for generating a driving force necessary to move the car body base 11 by the rolling wheels; and a cradle driving unit 14 configured to receive the driving force from the car body driving unit 13 for moving the cradle unit 2 back and forth.

As shown in FIG. 4A, the car body driving unit 13 comprises: a driving motor 131 having reduction gears; a driving force transmitting part 132 for transmitting a driving force generated from the driving motor 131 to driving wheels 133; and the driving wheels 133 configured to be rotated by the driving force transmitted through the driving force transmitting part 132. The driving force transmitting part 132 comprises: a first one-way bearing 1321 fitted on a shaft of the driving motor 131; a driving gear 1322 disposed on the outer circumferential surface of the first one-way bearing 1321; a driving force transmitting gear 1323 engaged with the driving gear 1322 for transmitting a driving force; a driven gear 1324 configured to be rotated while being engaged with the driving force transmitting gear 1323; a wheel driving shaft 1326 fitted in a center hole of the driven gear 1324 such that the wheel driving shaft 1326 is rotatably supported by a plurality of bearings 1325; a horizontal bevel gear 1327 attached to the lower end of the wheel driving shaft 1326; a vertical bevel gear 1328 engaged with the horizontal bevel gear 1327; a wheel shaft 1331 horizontally inserted in an inner hole defined in the vertical bevel gear 1328 such that the driving wheels 133 are attached to both ends of the wheel shaft 1331, respectively; and a driving wheel case 1329 rotatably fitted on the wheel driving shaft 1326 such that the driving wheels 133 are surrounded by the driving wheel case 1329, the driving wheel case 1329 being configured such that both ends of the wheel shaft 1331 are attached to the inner lower part of the driving wheel case 1329 while being rotatably supporting by bearings.

The first one-way bearing 1321 is a mechanical element configured to rotate only in one way. A second one-way bearing 141, which will be described below in detail, is identical to the first one-way bearing 1321 except that the second one-way bearing 141 is operated in the direction opposite to the direction in which the first one-way bearing 1321 is operated. When the motor shaft is rotated in the forward direction, the rotation of the first one-way bearing 1321 is restricted, and the rotation of the second one-way bearing 141 is allowed. As a result, the driving force is transmitted to components connected to the first one-way bearing 1321, not to components connected to the second one-way bearing 141. When the motor shaft is rotated in the reverse direction, on the other hand, the rotation of the second one-way bearing 141 is restricted, and the rotation of the first one-way bearing 1321 is allowed. As a result, the driving force is transmitted to components connected to the second one-way bearing 141, not to components connected to the first one-way bearing 1321.

The multifunctional electric-powered infant car with cradle function further comprises: a driving force control member for interrupting overload applied to the respective components constituting the driving force transmitting part 132 when the driving wheels 133 come into contact with an obstruction with the result that the driving wheels 133 are not rotated, and the driving wheels 133 malfunction, and for independently rotating the driving wheels 133. As shown in FIGS. 4A and 5A, the driving force control member comprises a torque spring 134 disposed on the outer circumference wheel shaft 1331. The torque spring 134 has one end securely connected to the vertical bevel gear 1328 and the other end securely connected to the corresponding driving wheel 133, which is rotatably attached to the wheel shaft 1331. The other driving wheel 133 is fixedly attached to the wheel shaft 1331 such that the driving wheel 133 is rotated along with the wheel shaft 1331, which is connected with the vertical bevel gear 1328.

The multifunctional electric-powered infant car with cradle function further comprises: a steering unit 15 for controlling the direction in which the driving wheels roll. As shown in FIG. 4C, the steering unit 15 comprises: a steering gear 151 disposed at the upper position of the outer circumferential surface of the driving wheel case 1329; a steering force transmitting gear 152 engaged with the steering gear 151; and a lower steering shaft 153 attached to the car body 1 such that the lower steering shaft 153 can be rotated through a bearing 154, the lower steering shaft 153 having the lower end fixedly inserted in the steering force transmitting gear 152. To the lower steering shaft 153 is connected an upper steering shaft 32, to which a steering wheel 31 of the steering wheel unit 3 is attached.

The upper steering shaft 32 is covered by a steering case 33, which is detachably attached to the car body 1 by a fixing member 35. On the steering case 33 is mounted a support bearing 34 for enabling the upper steering shaft 32 to be stably rotated. The upper and lower steering shafts 32 and 153 have an additional engaging/disengaging structure, by which the upper steering shaft 32 can be easily engaged with/disengaged from the lower steering shaft 153. As shown in FIG. 5B, the engaging/disengaging structure comprises: an inserting protrusion 321 formed at the lower end of the upper steering shaft 32, the inserting protrusion 321 having a fixing groove 322 formed thereon; a receiving protrusion 1531 formed at the upper end of the lower steering shaft 153, the receiving protrusion 1531 being formed in the shape of a rod whose center part is cut out in its longitudinal direction such that the inserting protrusion 321 can be inserted into the receiving protrusion 1531, the receiving protrusion 1531 being provided at the outer circumferential surface thereof with another fixing groove 1532; and a fixing ring 323 resiliently engaged in the fixing groove 322 of the inserting protrusion 321 and the fixing groove 1532 of the receiving protrusion 1531.

As shown in FIG. 4B, the cradle driving unit 14 comprises: a second one-way bearing 141 fitted on the shaft of the driving motor 131 while the second one-way bearing 141 is disposed above the first one-way bearing 1321, the second one-way bearing 141 being rotated in the direction opposite to the rotating direction of the first one-way bearing 1321; a driving pulley 142 fitted on the outer circumferential surface of the second one-way bearing 141; a driving belt 143 (preferably, a timing belt) having one side connected to the driving pulley 142 for transmitting a driving force; a driving force transmitting pulley 144 connected to the other side of the driving belt 143; a swing shaft 145 rotatably attached to the car body 1 such that the swing shaft 145 can be rotated by the driving force transmitting pulley 144; and a swing force transmitting member 147 for moving the cradle unit 2 back and forth by means of the driving force transmitted to the swing shaft 145.

Preferably, the swing force transmitting member 147 comprises: a rotary plate 1471 attached to the upper end of the swing shaft 145; swing levers 1472 vertically disposed in front of and at the rear of a supporting frame 21 of the cradle unit 2, which will be described below, respectively; a rubber belt 1473 connected between the swing levers 1472; and a connection piece 1474 for securely connecting the approximate middle part of the rubber belt 1473 and one side of the rotary plate 1471. When the rotary movement of the rotary plate 1471 is transmitted to the rubber belt 1473 via the connection piece 1474, the movement is transmitted to the swing levers 1472 connected to the supporting frame 21 while angular displacement is offset due to contraction and expansion of the rubber belt 1473. As a result, the cradle unit 2 is linearly reciprocated.

As shown in FIG. 1, the cradle unit 2 comprises: a supporting frame 21 mounted to the car body 1; a cradle body 22 attached to the supporting frame 21 such that the cradle body 22 can be moved back and forth; an inclination-adjustable back part 23 disposed in the center of the cradle body 22 such that the inclined angle of the inclination-adjustable back part 23 can be adjusted; and a swing locking/unlocking member 24 for allowing the cradle body 22 to swing back and forth about the supporting frame 21 or stopping the cradle body 22 from swinging back and forth about the supporting frame 21. The swing locking/unlocking member 24 has an adjusting lever for applying a manipulation force to the swing locking/unlocking member 24. The adjusting lever is exposed from one side of the cradle body 22.

As shown in FIG. 8, the multifunctional electric-powered infant car with cradle function according to the present invention further comprises: a driving input unit 41 having selection switches (not shown) for selecting the operation of the cradle unit 2 and the operation of the car body 1, respectively, and selection switches (not shown) for selecting the manual operation and the remote control operation, respectively; a control unit 42 for controlling the respective components, including the driving motor 130, based on the selection through the driving input unit 41; a remote controller receiving unit 44 for receiving control signals transmitted from a transmitting part of a remote controller 43 having a plurality of input buttons and transmitting the control signals to the control unit 42; a power supply unit 45 for supplying electric current to the respective components under the control of the control unit 42; a motor driving unit 46 for driving the driving motor 131 in the forward or reverse direction based on the control signals of the control unit 42; an overload detection unit 47 for detecting overload of the driving motor 131 and transmitting the detected overload to the control unit 42 to interrupt the operation of the driving motor 131; and a sound controller 48 for controlling sound of a sound device 5, including a speaker 51, under the control of the control unit 42.

The power supply unit 45 comprises: a storage battery 451 charged by a DC charger, to which external alternating current is supplied; an on/off switch 452 for allowing electric current charged in the storage battery 451 to be supplied to the respective components or stopping electric current charged in the storage battery 451 to be supplied to the respective components; and a light emitting diode for indicating that electric current is being supplied to the respective components.

During the use of the multifunctional electric-powered infant car with cradle function according to the present invention, the infant may incorrectly manipulate switches of the driving input unit 41 or disassemble the storage battery 451 of the power supply unit 45, which causes the multifunctional electric-powered infant car with cradle function to be damaged or the infant to be injured. For this reason, the multifunctional electric-powered infant car with cradle function according to the present invention further comprises: a protection cover 18 disposed at the rear part of the car body 1, as shown in FIG. 7. The protection cover 18 is hingedly connected to the car body 1 for selectively covering the driving input unit 41 and the power supply unit 45. The protection cover 18 is opened by pushing a button 19.

For example, the protection cover 18 has a hinge part formed at one end thereof, which is connected to the car body 1 by means of a hinge pin, and a spring is fitted on the hinge pin such that a resilient restoring force of the spring is applied in the direction where the protection cover is opened, although the protection cover 18 may have other different structures.

The sound device 5 is mounted on the protection cover 18, and the speaker 51 is mounted in the car body 1. In the sound device 5 are generally recorded voices of parents, which are provided to the infant through the speaker 51 in a predetermined fashion.

The operation of the multifunctional electric-powered infant car with cradle function according to the present invention will now be described.

When the electric-powered infant car with cradle function is used to feed the infant or let the infant play on the multifunctional electric-powered infant car with cradle function, the steering wheel unit 3, which is shown in FIG. 1, is separated from the car body 1, and then the infant is seated in the cradle unit 2. When the multifunctional electric-powered infant car with cradle function is used to put the infant to sleep, on the other hand, the inclination-adjustable back part 23 of the cradle unit 2 is inclined backward, as shown in FIG. 6, such that the multifunctional electric-powered infant car with cradle function according to the present invention can be used in the same fashion as an ordinary cradle.

The swing of the cradle unit 2 in the above-mentioned state is carried out as follows: when an input signal is applied to the control unit 42 through the manual operation or the remote control operation such that the cradle driving unit 14 is operated, as shown in FIG. 4B, the driving motor 131 is rotated in the reverse direction such that load is applied to the second one-way bearing 141. As a result, the driving pulley 142 is rotated, and therefore, a driving force is transmitted from the driving pulley 142 to the driving force transmitting pulley 144 via the driving belt 143. Consequently, the driving force transmitting pulley 144 is rotated, and therefore, the swing shaft 145 is also rotated. As the rotary plate 1471 is rotated along with the swing shaft 145, the driving force is transmitted to the rubber belt 1473 via the connection piece 1474. At this time, the rotary movement is converted into the linear reciprocating movement due to contraction and expansion of the rubber belt 1473. The linear reciprocating movement is transmitted to the swing levers 1472 connected to the supporting frame 21. Consequently, the cradle unit 2 is linearly reciprocated back and forth, as shown in FIG. 6.

While the infant is laid in the cradle unit 2, the electric-powered infant car with cradle function according to the present invention can be moved as follows: when an operation signal is applied to the control unit 42 through the manual operation or the remote control operation such that the car body driving unit 13 is operated, as shown in FIG. 4A, the driving motor 131 is rotated such that load is applied to the first one-way bearing 1321. As a result, a driving force from the driving motor 131 is transmitted to the wheel driving shaft 1326 through the driving gear 1322, driving force transmitting gear 1323, and the driven gear 1324, and therefore, the wheel driving shaft 1326 is rotated. As the wheel driving shaft 1326 is rotated, the horizontal bevel gear 1327 and the vertical bevel gear 1328 are rotated. At this time, the torque spring 134, one end of which is securely connected to the vertical bevel gear 1328, is pressed against the wheel shaft 1331. Consequently, the two driving wheels 133 are rotated simultaneously when the wheel shaft 1331 is rotated, and therefore, the car body 1 is moved by the rolling wheels 12.

When the driving wheels 133 come into contact with an obstruction or abnormal load is applied to the driving wheels 133 in the above-mentioned state, and therefore, load is applied to the vertical bevel gear 1328, the load is transmitted to the torque spring 134, one end of which is securely connected to the vertical bevel gear 1328. As a result, torsional moment is applied to the torque spring 134, and therefore, the inner diameter of the torque spring 134 is increased. Consequently, the torque spring 134 is not pressed against the wheel shaft 1331 any longer, and therefore, one of the driving wheels 133, to which the other end of the torque spring 134 is securely connected, is not rotated along with the wheel shaft 1331. In other words, the two driving wheels 133 are independently rotated. As a result, the direction in which the driving wheels are moved is smoothly changed. When the driving wheels 133 do not come into contact with the obstruction or the abnormal load is not applied to the driving wheels 133 any longer, the torque spring 134 is pressed against the wheel shaft 1331 again, and therefore, the driving force is uniformly transmitted to the two driving wheels 133.

The reason why both driving wheels 133 are not fixedly attached to the wheel shaft 1331 is as follows: If both driving wheels 133 are fixedly attached to the wheel shaft 1331, the entirety of the driving wheel case 1329 is rotated when the direction of the driving wheels 133 is changed as load is applied to the driving wheels 133. As a result, the floor where the driving wheels 133 are placed while being in contact with the floor, such as a laminated paper-covered floor or a wooden floor, is damaged. To solve the above problem, both driving wheels 133 are not fixedly attached to the wheel shaft 1331.

As the infant grows up, the present invention is used as an electric-powered infant car, instead of using the above-mentioned stationary or movable cradle. In this case, the steering wheel unit 3 is attached to the car body 1, as shown in FIGS. 2 and 4C. When the steering wheel 31 is rotated while the upper steering shaft 32 is securely attached to the steering wheel 31, the steering force transmitting gear 152 attached to the lower steering shaft 153 is rotated, and therefore, the driving wheel case 1329 is also rotated. As a result, the direction of the driving wheels 133 is changed. Consequently, the infant can drive the electric-powered infant car through the easy and simple manipulation of the steering wheel 31. In this way, the present invention is used as an electric-powered infant car.

Now, a second preferred embodiment of the present invention will be described in detail with reference to the accompanying drawings.

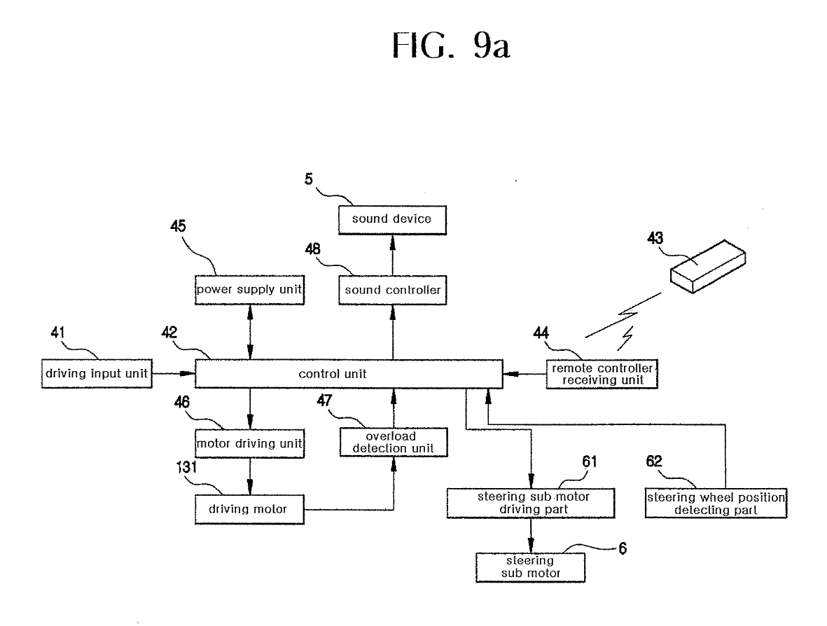

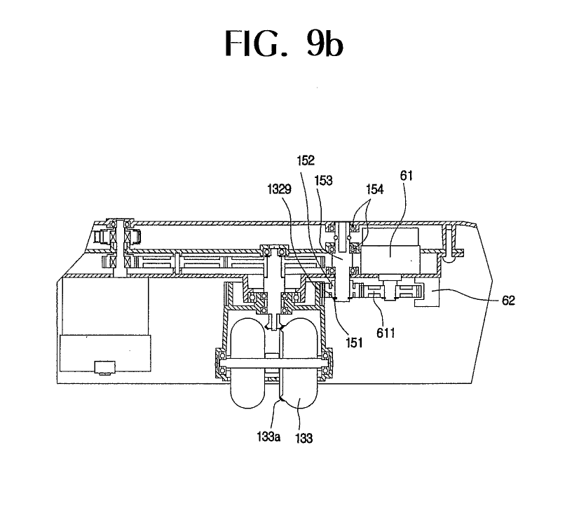

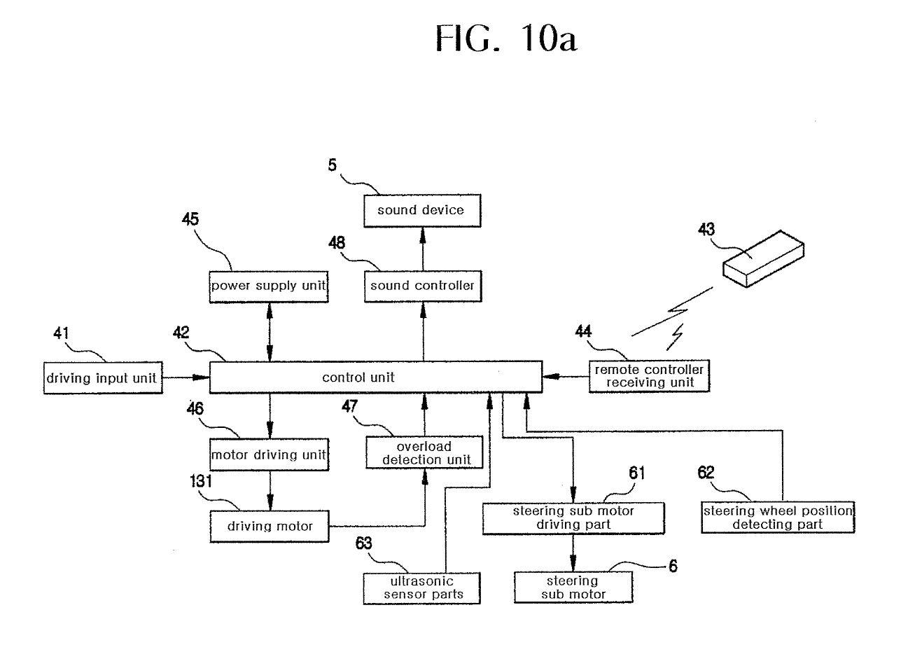

FIG. 9A is a block diagram illustrating the construction of a multifunctional electric-powered infant car with cradle function according to a second preferred embodiment of the present invention, and FIG. 9B is a sectional view, in part, schematically illustrating the structure of the multifunctional electric-powered infant car with cradle function according to the second preferred embodiment of the present invention. It should be noted that components of the multifunctional electric-powered infant car with cradle function according to the second preferred embodiment of the present invention, which correspond to those of the multifunctional electric-powered infant car with cradle function according to the first preferred embodiment of the present invention, are indicated by the same reference numerals as those of the multifunctional electric-powered infant car with cradle function according to the first preferred embodiment of the present invention.

The multifunctional electric-powered infant car with cradle function according to the second preferred embodiment of the present invention is similar in construction and operation to the multifunctional electric-powered infant car with cradle function according to the first preferred embodiment of the present invention except that the multifunctional electric-powered infant car with cradle function according to the second preferred embodiment of the present invention further comprises: a vertical bevel gear part 133a integrally attached to one of the driving wheels 133, which is engaged with the horizontal bevel gear 1327 attached to the wheel driving shaft 1326; and a steering sub motor 6 for controlling the direction in which the driving wheels 133 are moved, as shown in FIGS. 9A and 9B. The steering sub motor 6 has a shaft, on which a sub motor gear 611 is fitted. The sub motor gear 611 is engaged with the steering force transmitting gear 152 attached to the lower end of the lower steering shaft 153. The steering sub motor 6 comprises: a steering wheel position detecting part 62 (preferably, a detecting sensor) mounted adjacent to the sub motor gear 611 for detecting the position of the steering wheel; and a steering sub motor driving part 61 configured to receive the detected signal from the steering wheel position detecting part 62 for driving the steering sub motor 6 under the control of the control unit 42.

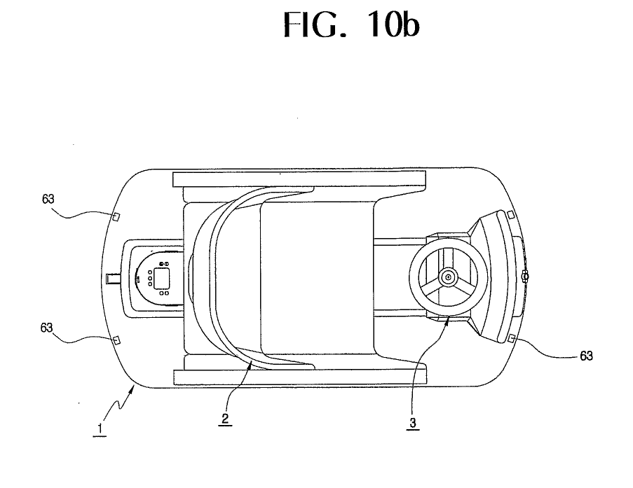

FIG. 10A is a block diagram illustrating the construction of the multifunctional electric-powered infant car with cradle function according to a third preferred embodiment of the present invention, and FIG. 10B is a plan view of the multifunctional electric-powered infant car with cradle function according to the third preferred embodiment of the present invention illustrating ultrasonic sensor parts mounted to the car body of the multifunctional electric-powered infant car with cradle function.

As shown in FIGS. 10A and 10B, the multifunctional electric-powered infant car with cradle function according to the third preferred embodiment of the present invention further comprises: a plurality of ultrasonic sensor parts 63 disposed at the front and rear ends of the car body 1 for detecting obstructions. When the obstructions are detected by the ultrasonic sensor parts 63, the detected signals are transmitted to the control unit 42 such that the steering sub motor 6 is operated, and therefore, the direction in which the driving wheels 133 are moved is changed.

The multifunctional electric-powered infant car with cradle function according to the third preferred embodiment of the present invention is similar in construction and operation to the multifunctional electric-powered infant car with cradle function according to the first preferred embodiment of the present invention except that the multifunctional electric-powered infant car with cradle function according to the third preferred embodiment of the present invention further comprises: the ultrasonic sensor parts 63 for detecting obstructions, and therefore, a detailed description of the other components of the multifunctional electric-powered infant car with cradle function according to the third preferred embodiment of the present invention will not be given.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A multifunctional electric-powered infant car with cradle function comprising: a car body having a plurality of rolling wheels attached thereto, the car body being configured such that the car body can be moved by driving wheels operated in an electric-powered fashion; and a cradle unit mounted on the car body such that the cradle unit can be moved back and forth, the cradle unit having a supporting frame vertically mounted to the car body and an inclination-adjustable back part for allowing an infant to be laid on the cradle unit, wherein the car body comprises:
a car body driving unit mounted to the bottom part of the car body base for transmitting a one-way rotating force generated from a driving motor to the driving wheels via a driving force transmitting part; and
a cradle driving unit configured to receive the driving force generated from the driving motor of the car body driving unit for moving the cradle unit back and forth.

2. The infant car as set forth in claim 1, wherein the driving force transmitting part comprises:
a first one-way bearing fitted on a shaft of the driving motor;
a driving gear disposed on the outer circumferential surface of the first one-way bearing;
a driving force transmitting gear engaged with the driving gear for transmitting a driving force;
a driven gear configured to be rotated while being engaged with the driving force transmitting gear;
a wheel driving shaft fitted in a center hole of the driven gear such that the wheel driving shaft is rotatably supported by a plurality of bearings;
a horizontal bevel gear attached to the lower end of the wheel driving shaft;
a vertical bevel gear engaged with the horizontal bevel gear;
a wheel shaft horizontally inserted in an inner hole defined in the vertical bevel gear such that the driving wheels are attached to both ends of the wheel shaft, respectively; and
a driving wheel case rotatably fitted on the wheel driving shaft such that the driving wheels are surrounded by the driving wheel case, the driving wheel case being configured such that both ends of the wheel shaft are rotatably attached to the inner lower part of the driving wheel case.

3. The infant car as set forth in claim 2, further comprising:
a torque spring for independently rotating the driving wheels when load is applied to the driving wheels, the torque spring having one end securely connected to the vertical bevel gear and the other end securely connected to one of the driving wheels, which is rotatably attached to the wheel shaft.

4. The infant car as set forth in claim 2, further comprising:
a steering wheel unit detachably attached to the car body in front of the cradle unit; and
a steering unit for controlling the direction in which the driving wheels roll through the manipulation of the steering wheel unit.

5. The infant car as set forth in claim 4, wherein the steering unit comprises:
a steering gear disposed at the upper position of the outer circumferential surface of the driving wheel case;
a steering force transmitting gear engaged with the steering gear; and
a lower steering shaft attached to the car body such that the lower steering shaft can be rotated through a bearing, the lower steering shaft having the lower end fixedly inserted in the steering force transmitting gear,
an upper steering shaft being detachably attached to the lower steering shaft.

6. The infant car as set forth in claim 1, wherein the driving force transmitting part comprises:
a first one-way bearing fitted on a shaft of the driving motor;
a driving gear disposed on the outer circumferential surface of the first one-way bearing;
a driving force transmitting gear engaged with the driving gear for transmitting a driving force;
a driven gear configured to be rotated while being engaged with the driving force transmitting gear;
a wheel driving shaft fitted in a center hole of the driven gear such that the wheel driving shaft is rotatably supported by a plurality of bearings;
a horizontal bevel gear attached to the lower end of the wheel driving shaft;
a vertical bevel gear part attached to one of the driving wheels, which is engaged with the horizontal bevel gear; and
a driving wheel case rotatably fitted on the wheel driving shaft such that the driving wheels are surrounded by the driving wheel case, the driving wheel case being configured such that both ends of the wheel shaft are rotatably attached to the inner lower part of the driving wheel case.

7. The infant car as set forth in claim 1, wherein the cradle driving unit comprises:
a second one-way bearing fitted on the shaft of the driving motor;
a driving pulley fitted on the outer circumferential surface of the second one-way bearing;
a driving belt having one side connected to the driving pulley for transmitting a driving force;
a driving force transmitting pulley connected to the other side of the driving belt;
a swing shaft rotatably attached to the car body such that the swing shaft can be rotated by the driving force transmitting pulley; and
a swing force transmitting member for moving the cradle unit back and forth by means of the driving force transmitted to the swing shaft.

8. The infant car as set forth in claim 7, wherein the swing force transmitting member comprises:
a rotary plate attached to the upper end of the swing shaft;
swing levers vertically disposed in front of and at the rear of the supporting frame of the cradle unit, respectively;
a rubber belt connected between the swing levers; and
a connection piece for securely connecting the approximate middle part of the rubber belt and one side of the rotary plate.

9. The infant car as set forth in claim 1, further comprising:
a driving input unit having selection switches for selecting the operation of the cradle unit and the operation of the car body, respectively, and selection switches for selecting the manual operation and the remote control operation, respectively;
a control unit for controlling the respective components, including the driving motor, based on the selection through the driving input unit;
a remote controller receiving unit for receiving control signals transmitted from a transmitting part of a remote controller having a plurality of input buttons and transmitting the control signals to the control unit;
a power supply unit for supplying electric current to the respective components under the control of the control unit;
a motor driving unit for driving the driving motor in the forward or reverse direction based on the control signals of the control unit;
an overload detection unit for detecting overload of the driving motor and transmitting the detected overload to the control unit; and
a sound controller for controlling sound of a sound device, including a speaker, under the control of the control unit.

10. The infant car as set forth in claim 9, further comprising:
a steering sub motor having a shaft, on which a sub motor gear is fitted such that the driving wheels are operated;
a steering wheel position detecting part mounted adjacent to the sub motor gear for detecting the position of a steering wheel; and
a steering sub motor driving part configured to receive the detected signal from the steering wheel position detecting part for driving the steering sub motor under the control of the control unit.

11. The infant car as set forth in claim 10, further comprising:
a plurality of ultrasonic sensor parts disposed at the front and rear ends of the car body for detecting obstructions such that the operation of the steering sub motor is controlled by the control unit based on signals detected by the ultrasonic sensor parts.

12. The infant car as set forth in claim 9, further comprising:
a protection cover hingedly connected to the car body for selectively covering the driving input unit and the power supply unit.
